(19) United States
(12) Patent Application Publication
(10) Pub. No.: US 2019/0004630 A1
(43) Pub. Date: Jan. 3, 2019

(54) THREE-DIMENSIONAL TOUCH SCREEN PANEL AND PRESSURE SENSING LAYER THEREOF

(71) Applicant: MELFAS INC., Seongnam-si, Gyeonggi-do (KR)

(72) Inventors: Seung Joon HAN, Seongnam-si, Gyeonggi-do (KR); Jin Tae KIM, Seongnam-si, Gyeonggi-do (KR)

(73) Assignee: MELFAS INC., Seongnam-si, Gyeonggi-do (KR)

(21) Appl. No.: 16/061,843

(22) PCT Filed: Oct. 25, 2016
(86) PCT No.: PCT/KR2016/011994

§ 371 Date: Jun. 13, 2018

(30) Foreign Application Priority Data
Dec. 14, 2015 (KR) 10-2015-0178355
Dec. 14, 2015 (KR) 10-2015-0178363
Dec. 14, 2015 (KR) 10-2015-0178368
Dec. 22, 2015 (KR) 10-2015-0183660
Jan. 4, 2016 (KR) 10-2016-0000440

(51) Int. Cl. G06F 3/044; G02F 1/1333; G02F 1/1343

(52) U.S. Cl. CPC G06F 3/044; G02F 1/13338; G02F 1/133514; G02F 1/134309; G02F 2202/103; G02F 1/133308

(57) ABSTRACT

A three-dimensional touch screen panel including: a touch surface to which a user's touch is applied; a first electrode positioned below the touch surface and made of a conductive material; and a second electrode positioned below the first electrode so as to be spaced apart from the first electrode, and made of a conductive material. The gap between the first electrode and the second electrode changes according to a magnitude of pressure applied to the touch surface, one of the first electrode or the second electrode has one or more penetration parts penetrating in the thickness direction, and the area of the one or more penetration parts gradually increases from an edge to the center.

### TECHNICAL FIELD

The present invention relates to a three-dimensional touch screen panel capable of detecting both a pressure and a touch and a pressure sensing layer thereof.

### BACKGROUND ART

As the market of smart phones expands, various touch screen panels are emerging. A touch screen panel may generally obtain the presence or absence of a touch input and a position of the touch input. Recently, a three-dimensional touch screen panel capable of sensing both a position of a touch input and intensity of a touch pressure is used.

### DISCLOSURE

### Technical Problem

A conventional three-dimensional touch panel, which senses intensity of a touch pressure, may differently recognize intensity of a pressure according to a touch position due to a limitation of a mechanical structure. The present invention is directed to providing a three-dimensional touch panel capable of sensing intensity of a pressure regardless of a touch position on the three-dimensional touch panel, and a pressure sensing layer thereof.

### Technical Solution

One aspect of the present invention provides a three-dimensional touch screen panel including a touch surface to which a user's touch is applied, a first electrode made of a conductive material and positioned below the touch surface, and a second electrode made of a conductive material and spaced apart from and below the first electrode, wherein a distance between the first electrode and the second electrode is varied according to a pressure applied to the touch surface, one or more penetration parts penetrating in a thickness direction are formed at either the first electrode or the second electrode, and the one or more penetration parts increase in area from an edge to a center.

### Advantageous Effects

In accordance with the present invention, a uniform touch interface can be provided for a user without deviation resulting from a touch position when a touch is made with the same intensity of a pressure.

### DESCRIPTION OF DRAWINGS

FIG. 1 is a cross-sectional view of an example of a touch panel.

FIG. 2 is a cross-sectional view of another example of the touch panel.

FIGS. 3 to 5 are diagrams illustrating a detected pressure distribution of each of panel positions after a test pressure is applied to a touch panel having a sheet-shaped pressure sensing layer.

FIG. 6 is a plan view of another example of the pressure sensing layer.

FIG. 7 is a plan view of still another example of the pressure sensing layer.

FIG. 8 is a plan view of yet another example of the pressure sensing layer.

FIG. 9 is a graph showing a pressure distribution (Pattern 1) in a touch panel having a sheet-shaped pressure sensing layer and a pressure distribution (Pattern 2) in a touch panel having a pressure sensing layer according to an embodiment of the present invention.

FIG. 10 is a schematic cross-sectional view of a three-dimensional touch screen panel according to a first embodiment.

FIG. 11 is a schematic cross-sectional view of a three-dimensional touch screen panel according to a second embodiment.

FIG. 12 is a schematic cross-sectional view of the three-dimensional touch screen panel according to the second embodiment.

FIG. 13 is a schematic cross-sectional view of a three-dimensional touch screen panel according to a third embodiment.

FIG. 14 is a schematic cross-sectional view of a three-dimensional touch screen panel according to a fourth embodiment.

FIGS. 15 to 17 are schematic cross-sectional views of a liquid crystal display (LCD) module according to the fourth embodiment.

### MODES OF THE INVENTION

The technique, which will be described below, may be modified into various forms and may have a variety of embodiments, and, therefore, specific embodiments will be illustrated in the drawings and described in detail. The embodiments, however, are not to be taken in a sense for limiting the technique, which will be described below, to the specific embodiments, and should be construed to include modifications, equivalents, or substitutes within the spirit and technical scope of the technique which will be described below.

The terms first, second, A, B, and the like may be used to describe various components, but the components are not limited by these terms, and the terms may be used only to distinguish one component from another. For example, without departing from the scope of the present technique which will be described below, a first component may be referred to as a second component, and similarly, a second component may also be referred to as a first component. The term “and/or” includes a combination of a plurality of related listed items and any one item of the plurality of related listed items.

In this disclosure, the singular form should be understood to include the plural form unless the context clearly dictates otherwise, and the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

Before describing the drawings in detail, it should be noted that the discrimination of constituent parts in this disclosure is merely made by a main function of each of the constituent parts. That is, two or more constituent parts which will be described below may be combined into a single constituent part, or a single constituent part may be divided into two or more constituent parts according to more segmented functions. Further, each of the constituent parts which will be described below may additionally perform some or all of functions of other constituent part in addition to its main function, and some of the main function of each of the constituent parts may also be carried out by other constituent part as a dedicated function thereof.

A touch panel which will be described below is a conventional device capable of recognizing intensity of a touch input (intensity of a pressure). A three-dimensional touch panel which will be described below may include a configuration for determining the presence or absence of a touch or a position of the touch as in a conventional three-dimensional touch panel. Hereinafter, a conventional configuration for determining the presence or absence of a touch or a position of the touch is referred to as a touch panel. A touch sensing part means to include an electrode layer (a touch sensor) for sensing a touch, a driving circuit for applying a signal to the electrode layer, and an integrated circuit (IC) for controlling the driving circuit. The touch sensing part may be configured with various types such as a capacitive type, a resistive type, an infrared type, a surface acoustic wave (SAW) type, an electromagnetic type, an acoustic pulse recognition (APR) type, an optical type, and the like. A device such as a smart phone mainly employs a capacitive type. The capacitive type mainly uses a projected capacitive (PCAP) method. The PCAP method is divided into a self-capacitive method using self-capacitance and a mutual-capacitive method using mutual capacitance.

A three-dimensional touch screen panel according to an embodiment of the present invention may be applied to an electronic device providing a touch screen, such as a smart phone, a tablet personal computer (PC), a personal digital assistant (PDA), a notebook, and the like.

In the technique which will be described below, the touch sensing part may use various methods. The technique which will be described below relates to a three-dimensional touch panel for measuring a degree of intensity of a touch pressure. Therefore, a detailed description of a conventional touch sensing part will be omitted below.

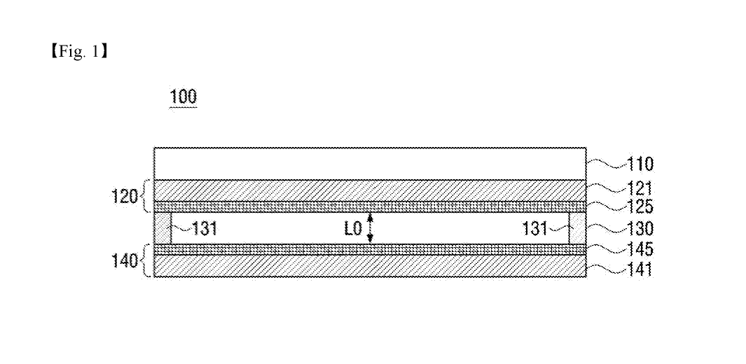

Hereinafter, a three-dimensional touch panel will be described in detail with reference to the drawings. FIG. 1 is a cross-sectional view of an example of a three-dimensional touch panel 100. FIG. 1A is an example of the three-dimensional touch panel 100 configured to determine a magnitude of a touch pressure using mutual capacitance. A driving circuit, a control circuit, and the like are not shown in FIG. 1.

FIG. 1 is a diagram illustrating an example of a basic configuration for measuring intensity of a touch pressure in the three-dimensional touch panel 100. In FIG. 1, only a main configuration of the three-dimensional touch panel 100 is shown and a display panel is not shown. Referring to FIG. 1, the three-dimensional touch panel 100 includes a touch sensing part 110, a first electrode layer 120, a spacer layer 130, and a second electrode layer 140.

The touch sensing part 110 senses the presence or absence of a user's touch input and a position of the touch input.

The first electrode layer 120 is positioned below the touch sensing part 110. The first electrode layer 120 includes a first insulating film 121 and a first electrode 125. The first insulating film 121 is made of an insulating material through which a current does not flow. The first insulating film 121 may be made of a thin transparent plastic film such as polyethylene terephthalate (PET). For example, the first electrode 125 may include a single electrode which is integrally formed in a sheet shape. As another example, the first electrode 125 may include a plurality of electrodes formed in one direction (a first direction). A shape of the first electrode 125 will be described in detail below. The first electrode 125 is made of a material through which a current flows. The first electrode 125 may be configured to include at least one among a transparent indium tin oxide (ITO) having a uniform thickness and made of tin oxide (SnO₂) and indium oxide (In₂O₃), silver ink, and a copper or carbon nanotube (CNT).

The second electrode layer 140 is positioned below the first electrode layer 120. The second electrode layer 140 includes a second insulating film 141 and a second electrode 145. The second insulating film 141 is made of an insulating material through which a current does not flow. The second insulating film 141 may be made of a thin transparent plastic film such as PET. For example, the second electrode 145 may include a single electrode which is integrally formed. As another example, the second electrode 145 may include a plurality of electrodes formed in a direction (a second direction) different from the first direction. The second electrode 145 is made of a material through which a current flows. The second electrode 145 may be configured to include at least one among a transparent ITO having a uniform thickness and made of SnO₂ and In₂O₃, silver ink, and a copper or a CNT.

The spacer layer 130 is positioned between the first electrode layer 120 and the second electrode layer 140. The spacer layer 130 is a configuration for securing a predetermined space between the first electrode layer 120 and the second electrode layer 140. The spacer layer 130 may include an inner spacing member 131 for supporting the first electrode layer 120 and the second electrode layer 140. The spacer layer 130 may be filled with a dielectric substance. The dielectric substance includes a material such as an open cell foam, gel, a lightly linked polymer, and the like. For example, the spacer layer 130 may be filled with air.

The first electrode 130 or the second electrode 140 may be a metal layer. The three-dimensional touch panel may further include a display panel, and a metal layer may be an electrode layer included in the display panel. The three-dimensional touch panel may further include a middle frame configured to house the three-dimensional touch panel, and a metal layer may be the middle frame. The three-dimensional touch panel may further include a blocking frame configured to block between the three-dimensional touch panel and electric components including a battery, and a metal layer may be the blocking frame. Hereinafter, a detailed description thereof will be described with reference to embodiments.

The first electrode layer 120, the spacer layer 130, and the second electrode layer 140 are main components for measuring intensity of a touch pressure. For convenience of description, a panel including the first electrode layer 120, the spacer layer 130, and the second electrode layer 140 will be referred to as a “touch pressure panel” below.

An internal configuration of the three-dimensional touch panel 100 may be different from that shown in FIG. 1. For example, the touch sensing part 110, the first electrode layer 120, and the second electrode layer 140 may be vertically stacked in an order different from that shown in FIG. 1. Further, the stacking order of layers constituting the touch pressure panel may also be changed. However, the spacer layer 130 should be always positioned between the first electrode layer 120 and the second electrode layer 140. Further, the first electrode layer 120 or the second electrode layer 140 may use an electrode layer included in the touch sensing part 110. In this case, a portion of a configuration of the touch sensing part 110 configured to determine a position of a touch input and a portion of a configuration of the touch pressure panel configured to determine intensity of a touch pressure are shared.

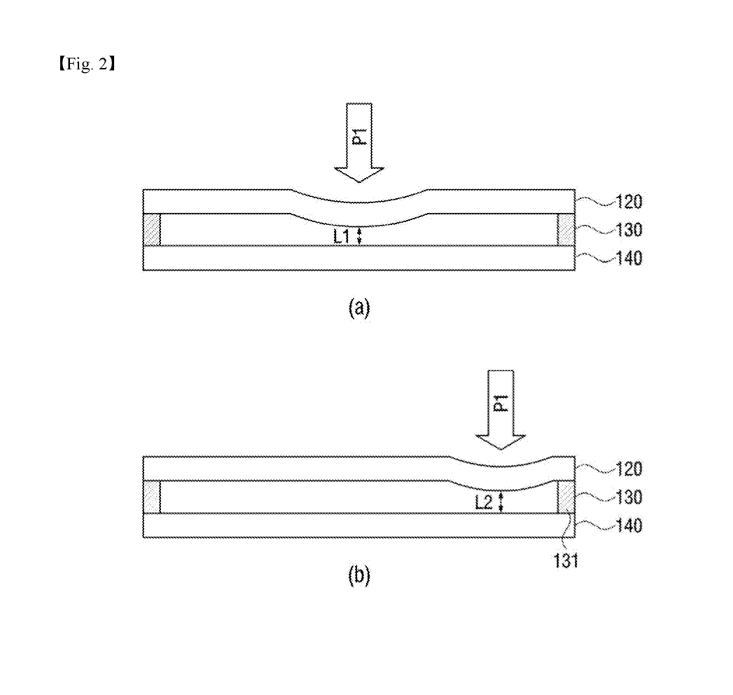

FIG. 2 is a diagram illustrating an example of only a configuration of the touch pressure panel in FIG. 1. A basic principle of measuring intensity of a touch pressure will be described with reference to FIG. 2B. FIG. 2B is a diagram illustrating an example in which a touch input having intensity of P1 is applied to a central area of the touch pressure panel.

When a user presses a touch surface on the touch sensing part 110, the first electrode layer 120 is physically and constantly bent by a touch pressure. When the first electrode layer 120 is bent, a distance between the first electrode layer 120 and the second electrode layer 130 becomes closer. Referring to FIG. 1, a distance between the first electrode layer 120 and the second electrode layer 140 is “L0” in the absence of a touch input. Referring to FIG. 2B, the distance between the first electrode layer 120 and the second electrode layer 140 becomes closer by the touch input. In FIG. 2B, the distance between the first electrode layer 120 and the second electrode layer 140 is “L1” that is smaller than “L0.” When the distance between the first electrode layer 120 and the second electrode layer 140 becomes closer, self-capacitance between the first electrode layer 120 and the second electrode layer 140 is changed. As the distance between the first electrode layer 120 and the second electrode layer 140 becomes closer, the self-capacitance becomes smaller.

The self-capacitance between the first electrode layer 120 and the second electrode layer 140 in the absence of a touch input will be referred to as reference capacitance Cm. Intensity of a touch pressure may be determined by measuring a variation ΔCm in self-capacitance between the first electrode layer 120 and the second electrode layer 140 relative to the reference capacitance. That is, the intensity of the touch pressure may be determined by the variation in self-capacitance from an instant when a touch begins.

The distance between the first electrode layer 120 and the second electrode layer 140 may be varied according to a position at which a touch input occurs even when the same pressure is applied. FIG. 2B is a diagram illustrating an example of only a configuration of a first touch pressure panel in FIG. 1. Unlike FIG. 2A, FIG. 2B illustrates a case in which a touch input having intensity of P1 is applied to an edge of the touch pressure panel. FIG. 2B illustrates a case in which the touch pressure having the intensity of P1 equal to that shown in FIG. 2A is applied.

The inner spacing member 131 is provided at an edge of the spacer layer 130. The inner spacing member 131 may have various mechanical configurations. When a touch input occurs around the inner spacing member 131, a predetermined repulsive force is generated in a direction opposite a direction of the touch pressure due to a physical structure of the inner spacing member 131. Therefore, even though the touch pressure having the intensity of P1 is applied to the edge of the first touch pressure panel, the distance between the first electrode layer 120 and the second electrode layer 140 may be different from that therebetween of FIG. 2A. Referring to FIG. 2B, the distance between the first electrode layer 120 and the second electrode layer 140 is “L2” that is longer than “L1.” A relationship of L1<L2<L0 is established.

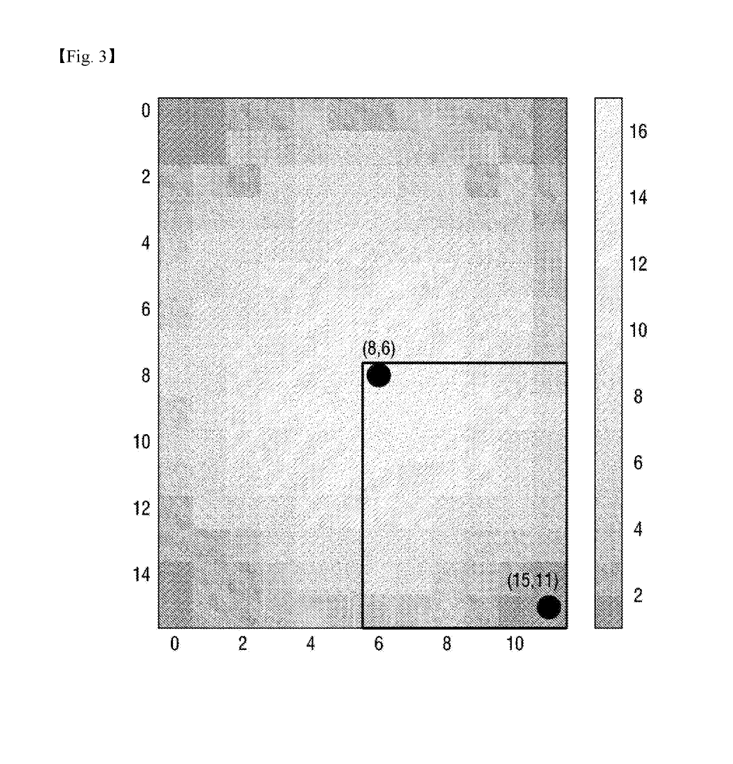

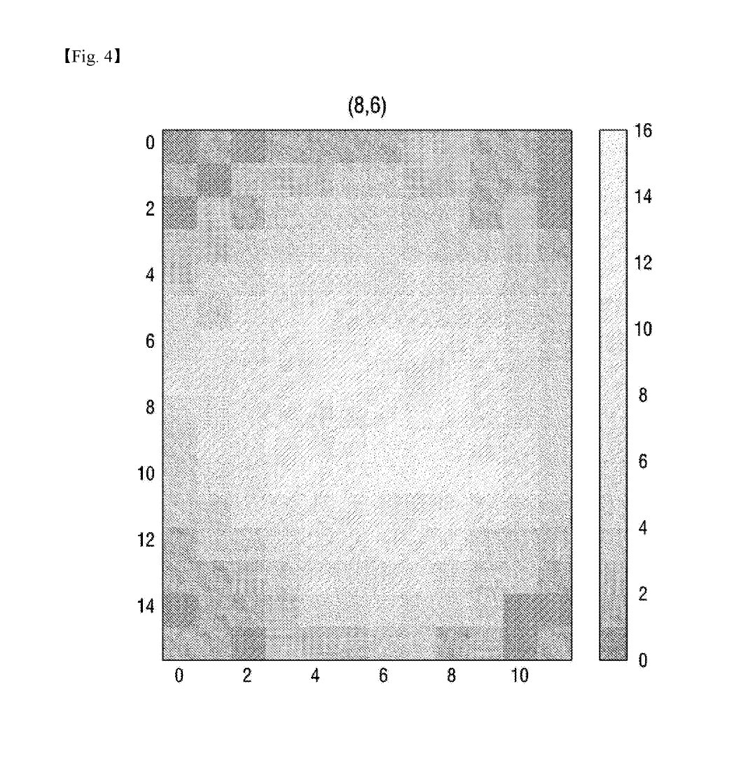

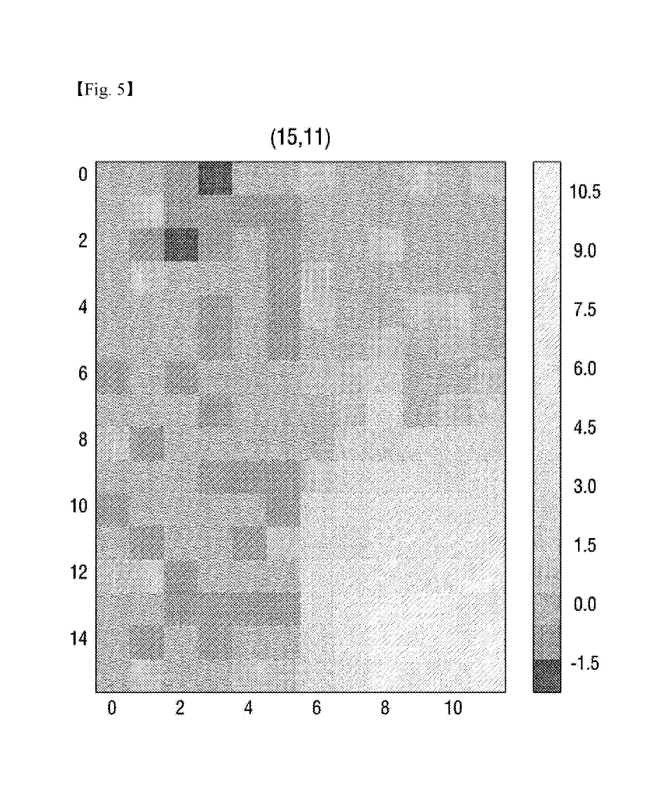

Meanwhile, FIGS. 3 to 5 are diagrams illustrating a pressure distribution exhibiting when a pressure is applied to a test electrode which is configured in a single sheet shape. Numbers on a vertical axis and a horizontal axis represent coordinates. A pressure magnitude according to intensity of a touch is represented by a color of a right-hand bar graph. FIG. 4 is a diagram illustrating a pressure distribution exhibiting when a touch pressure is applied to a central region, i.e., Position (8, 6) of the test electrode, and FIG. 5 is a diagram illustrating a pressure distribution exhibiting when a touch pressure is applied to Position (15, 11).

As shown in the drawings, a displacement L2 when the touch pressure is applied to Position (15, 11) adjacent to an edge region becomes smaller than a displacement L1 when the touch pressure is applied to the central region, i.e., Position (8, 6) because of generation of a predetermined repulsive force in a direction opposite the direction of the touch pressure due to the physical structure of the inner spacing member 131. Therefore, a magnitude of the touch pressure may be differently detected according to a touch position even when a force having the same intensity is applied.

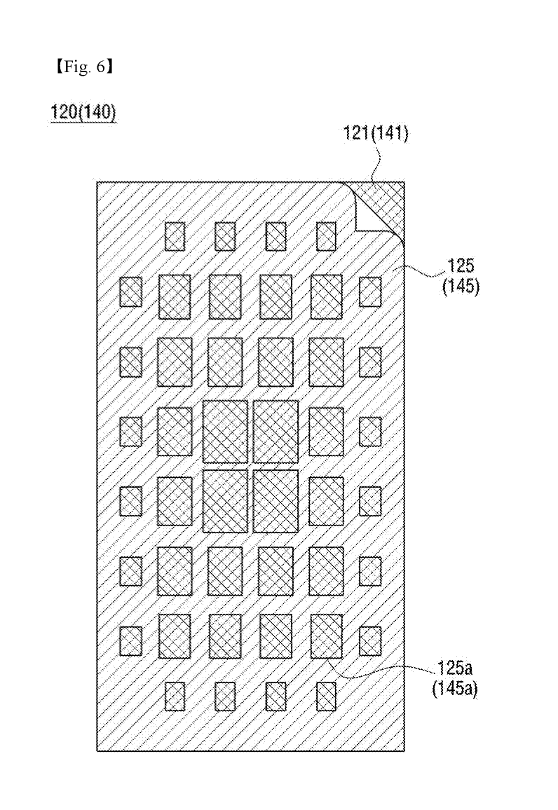

In the embodiment of the present invention, in order to correct a magnitude of a pressure which is differently detected according to a touch position on a touch surface when a force having the same intensity is applied, a penetration part 125a or 145a and/or an incised part 125b or 145b is formed at the first electrode 125 or the second electrode 145. A pattern of an electrode at which the penetration part 125a or 145a and/or the incised part 125b or 145b is formed will be described below with reference to FIGS. 6 to 8.

FIGS. 6 to 8 are plan views for describing various examples of a first electrode 125 or a second electrode 145 according to an embodiment of the present invention.

As shown in FIG. 6, according to the embodiment of the present invention, the first electrode 125 or the second electrode 145 may be configured in a single sheet shape. A plurality of penetration parts 125a or 145a may be formed at the first electrode 125 or the second electrode 145. It is preferable that a penetration area of each of the plurality of penetration parts 125a or 145a increases from an edge of the electrode 125 or 145 toward a center thereof as in the embodiment of FIG. 6. A reference numeral 121 or 141 denotes an insulating film.

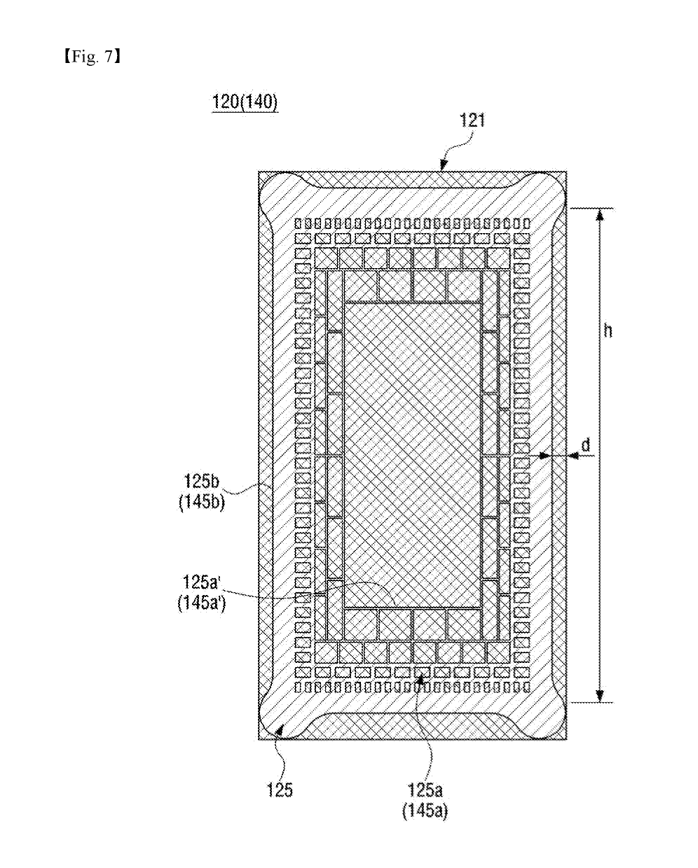

As shown in FIG. 7, according to the embodiment of the present invention, a plurality of penetration parts 125a or 145a may be formed at the first electrode 125 or the second electrode 145. The penetration part 125a or 145a may be formed to increase in area from the edge to the center. Further, an incised part 125b or 145b which is incised inward with a set length h and a set width d may be formed at one or more edges of the first electrode 125 or the second electrode 145. In addition, a penetration part 125c or 145c is formed such that a penetration area ranging from the center of the first electrode 125 or the second electrode 145 to a ¼ length of each edge becomes 20% of an entire penetration area, preferably 50% thereof.

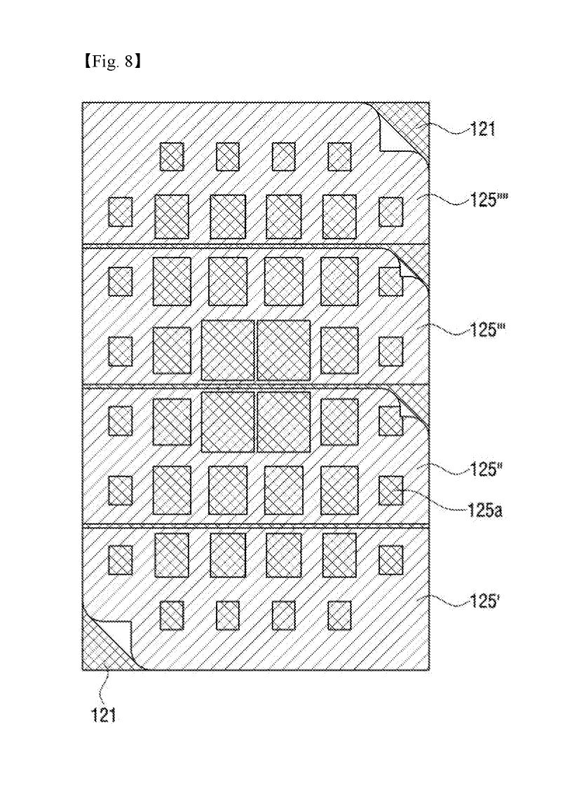

As shown in FIG. 8, the electrode may be configured with a plurality of separate electrodes 125′, 125″, 125′″, and 125″″. When the electrode is configured with the plurality of separate electrodes, a pressure position may be measured.

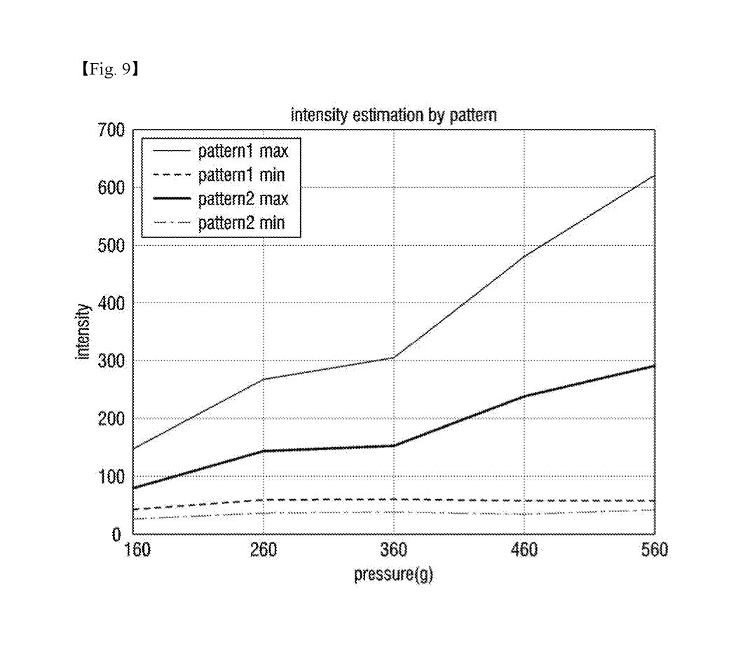

FIG. 9 is a graph showing a magnitude of an applied touch and a detected pressure value in a case (Pattern 1) of using an electrode at which the penetration part 125a or 145a and/or the incised part 125b or 145b is not formed and a case (Pattern 2) of using an electrode at which the penetration part 125a or 145a and/or the incised part 125b or 145b is formed. As shown in the drawing, it can be seen that a difference between a maximum value and a minimum value of a pressure is corrected within a set range in Pattern 2 using the electrode at which the penetration part 125a or 145a and/or the incised part 125b or 145b is formed.

The first electrode layer 120 or the second electrode layer 140 may be called as a pressure sensing layer. The pressure sensing layer detects pressure intensity when a touch event occurs. When a plurality of penetration parts are formed at the pressure sensing layer, it is possible to correct occurrence of an error in pressure magnitude detection between when a central portion of a touch surface is touched and an edge portion thereof is touched.

That is, the distance between the first electrode layer 120 and the second electrode layer 140 is varied according to a pressure magnitude when the user touches the touch surface, and thus even though the same force is applied when the user touches a central area of a panel and an edge thereof, the displacements L1 and L2 are different from each other, but in the case of the pressure sensing layer according to the above-described embodiment, i.e., the electrode 125 or 145, the penetration part 125a or 145a and/or the incised part 125b or 145b is formed, such that a capacitance value may be corrected and thus occurrence of an error in pressure magnitude may be corrected.

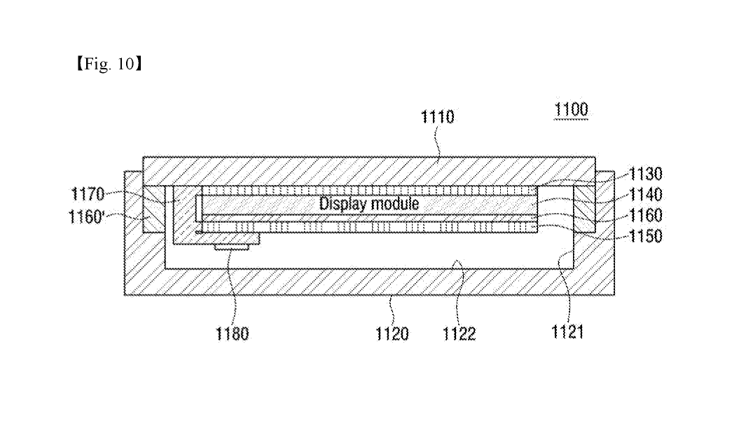

Hereinafter, embodiments of a three-dimensional touch screen panel to which the above-described pressure sensing layer is applied will be described with reference to FIGS. 10 to 17.

FIG. 10 is a schematic cross-sectional view of the three-dimensional touch screen panel according to a first embodiment. As shown in the drawing, a three-dimensional touch screen panel 1100 according to the first embodiment of the present invention includes a screen cover 1110, a frame 1120, a touch sensing part 1130, a display module 1140, a pressure sensing layer 1150, an adhesive layer 1160, a printed circuit board (PCB) module 1170, and a control integrated circuit (IC) 1180.

The screen cover 1110 may serve as a user's touch surface. In a capacitive type touch screen panel, it is preferable that the screen cover 1110 is made of a material having a uniform dielectric constant and has a uniform thickness for a normal operation. For example, the screen cover 1110 may be made of a material such as PET, glass, or the like.

The frame 1120 may be a support frame configured to house a touch screen panel, a middle frame configured to partition a display panel and electric components including a battery, or a blocking frame configured to block noise due to an electrical signal of a touch screen panel including a display panel. In the embodiment shown in the drawing, the frame 1120 will be described as an example of the support frame configured to house the touch screen panel. The frame 1120 is formed to have a central opening through which the screen cover 1110 may be disposed and house the three-dimensional touch screen panel 1100 by being spaced apart from the pressure sensing layer 1150 by a set distance. Edges of the layers 1130, 1140 and 1150 including the screen cover 1110 may be connected and fixed to the frame 1120. The edges may be fixed by an additional frame. The edges of the layers 1130, 1140 and 1150 including the screen cover 1110 may be fixed by a separate frame. A spacing member 1121 is preferably formed at the frame 1120 to support the frame 1120 to be spaced apart from the pressure sensing layer 1150 by a set distance. The spacing member 1121 may be formed by disposing a separate member or by pressing a side wall of the frame 1120. The frame 1120 is made of a conductive material to form capacitance between the frame 1120 and the pressure sensing layer 1150. The frame 1120 is preferably formed of a metal. A separation distance between the frame 1120 and the pressure sensing layer 1150 is set such that, even though the pressure sensing layer 1150 is displaced when a maximum pressure is applied to the screen cover 1110, the frame 1120 and the pressure sensing layer 1150 are not in contact with each other.

The touch sensing part 1130 is configured to be coupled to the screen cover 1110 and detect a touch event and a touch position for the screen cover 1110.

The display module 1140 is coupled to the screen cover 1110 by interposing the touch sensing part 1130 to emit light constituting screen information. The display module 1140 may include at least one among a light emitting diode (LED), a liquid crystal display (LCD), a thin film transistor (TFT) LCD, an organic light emitting diode (OLED), a flexible display, a three-dimensional display, and an electronic paper.

The pressure sensing layer 1150 is formed of a sheet made of a conductive material to detect pressure intensity when a touch event occurs. Preferably, the pressure sensing layer 1150 employs the electrodes as shown in FIGS. 6 to 8. The plurality of penetration parts 125a as shown in FIGS. 6 to 8 may be formed at the pressure sensing layer 1150 from the edge of the pressure sensing layer 1150 to a central portion thereof. Each of the plurality of penetration parts 125a is preferably formed to increase in area from an edge of the penetration part 125a to a central portion thereof. A spacing member 1121 is disposed at the edge of the pressure sensing layer 1150 when the pressure sensing layer 1150 is assembled with the frame 1120, and thus a distance between the pressure sensing layer 1150 and the frame 1120 is maintained, and the plurality of penetration parts 125a are formed in consideration of a repulsive force by the spacing member 1121, a distance from the spacing member 1121, and an error in pressure intensity due to the repulsive force such that correction for pressure intensity measurement may be made. The pressure sensing layer 1150 may be formed such that a penetration area of the central portion thereof is to be 20% or more, and a penetration area of a central region thereof is to be 50% or more of an entire penetration area of the pressure sensing layer 1150. A penetration part 125a′ having a ¼ area or more relative to an entire area of the pressure sensing layer 150 may be formed at the center of the pressure sensing layer 1150. Further, as shown in FIG. 7, an incised part 125b which is incised inward with a set length h and a set width d may be formed at one or more edges of the pressure sensing layer 1150. When the penetration part 125a and/or the incised part 125b is formed at the pressure sensing layer 1150, it is possible to correct an error in pressure magnitude detection between when a central portion of the screen cover 1110 is touched and when an edge of the screen cover 1110 is touched. The pressure sensing layer 1150 may be coupled to a front surface or a rear surface of the display module 1140, and when the pressure sensing layer 1150 is disposed at the front surface of the display module 1140, the pressure sensing layer 1150 is preferably made of a transparent conductive material.

The adhesive layer 1160 adheres and couples the pressure sensing layer 1150 to the display module 1140. An optical clear adhesive (OCA), an optical clear resin (OCR), a pressure sensitive adhesive material or an ultraviolet ray curable adhesive material, a double-sided adhesive tape, and the like may be used. The PCB module 1170 connects the touch sensing part 1130, the pressure sensing layer 1150, and the control IC 1180 to transmit a signal thereto. It is preferable to use a flexible PCB module. The control IC 1180 is one of main components constituting the touch screen panel, is configured with a signal source, a multiplexer, and an analog to digital (A/D) converter, converts an analog signal transmitted from the touch screen panel into a digital signal, controls data (a coordinate value and the like) required for determining coordinates of a touch area and a magnitude of a touch pressure, and transmits the data to a host (a smart phone application (AP), a microcontroller, and the like).

The screen cover 1110, the touch sensing part 1130, the display module 1140, and the pressure sensing layer 1150, which are combined in the three-dimensional touch screen panel 1100 according to the embodiment of the present invention which is configured as described above, are coupled to the frame 1120 by an adhesive member 1160′ and are disposed and spaced apart from a bottom surface 1122 of the frame 1120 by the spacing member 1121 of the frame 1120. The coupled layers may be preferably coupled to the frame 1120 so as to allow a distance from the bottom surface 1122 of the frame 1120 to be varied according to a magnitude of a pressure when the user touches the screen cover 1110, or the coupled layers may preferably have elasticity so as to allow the distance from the bottom surface 1122 of the frame 1120 to be varied according to the magnitude of the pressure when the screen cover 1110 is touched and so as to restore to its original position when the pressure is released. The bottom surface of the frame 1120 and the pressure sensing layer 1150 are configured to be insulated even when a pressure is applied to the screen cover 1110.

Meanwhile, the microcontroller which is not included in the drawing determines a touch event, a touch position, and a pressure magnitude according to signals applied from the touch sensing part 1130 and the pressure sensing layer 1150. For example, the microcontroller includes a processor, a device driver, and an interface circuit which are integrated into a single IC chip or a structure, or are operably disposed on a motherboard. The microcontroller executes commands stored by firmware and/or software (not shown). In the above-described embodiment, the microcontroller determines the pressure magnitude according to the signal applied from the pressure sensing layer 1150, but the present invention is not limited thereto, the microcontroller may be connected to the frame 1120 and may determine the pressure magnitude according to a signal applied from the frame 1120.

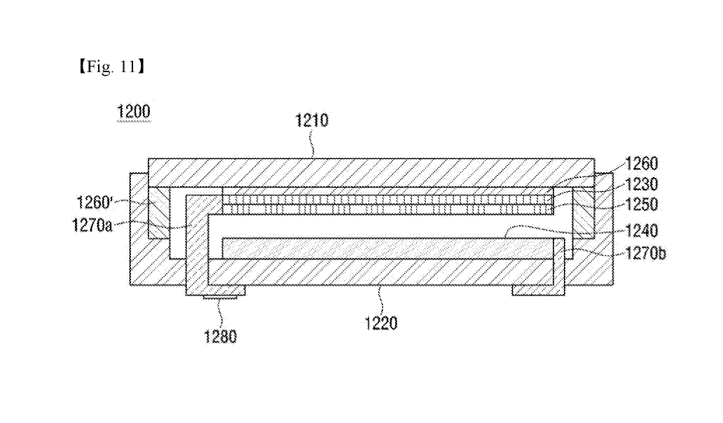

FIG. 11 is a schematic cross-sectional view of a three-dimensional touch screen panel according to a second embodiment. FIG. 11 illustrates the second embodiment in which a metal layer is an electrode layer of a display panel. As shown in the drawing, a three-dimensional touch screen panel 1200 according to the second embodiment of the present invention includes a screen cover 1210, a pressure sensing layer 1250, a touch sensing part 1230, a display module 1240, a support frame 1220, an adhesive layer 1260, a PCB module 1270, and a control IC 1280. A description of a configuration overlapping with the configuration of the above-described first embodiment will be omitted.

The screen cover 1210 serves as a user's touch surface. The touch sensing part 1230 is configured to be coupled to the screen cover 1210 and detect a touch event and a touch position for the screen cover 1210. In order to prevent generation of noise when the pressure sensing layer 1220 detects a pressure magnitude, an electrode layer included in the touch sensing part 1230 may be set to the ground or a set voltage.

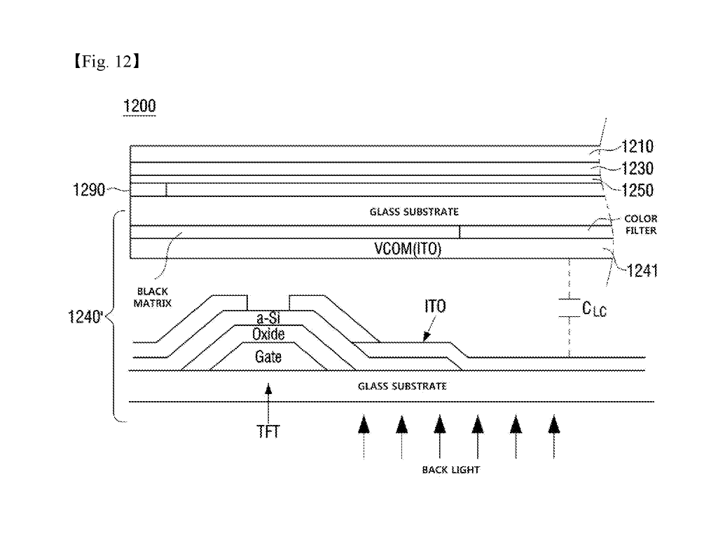

The display module 1240 is disposed and spaced apart from the pressure sensing layer 1250 by a predetermined distance to emit light constituting screen information. The display module 1240 may include at least one among an LED, an LCD, a TFT-LCD, an OLED, a flexible display, a three-dimensional display, and an electronic paper. Meanwhile, FIG. 12 is a partial cross-sectional view for illustrating an embodiment employing an LCD display panel 1240′ as a display panel of the three-dimensional touch screen panel 1200 in detail. As shown in the drawing, a common electrode (VCOM) layer 1241 is formed at a glass substrate constituting the flat LCD display module 1240′. A spacing member 1290 is coupled between the glass substrate on which the common electrode layer 1241 is formed and the pressure sensing layer 1250 so that the electrode layer 1241 and the pressure sensing layer 1250 are not in contact with each other. The spacing member 1290 has elasticity to allow the screen cover 1250 to return to its original state after being displaced by a touch. An OCA, an OCR, a pressure sensitive adhesive material, or a transparent double-sided tape (DST) may be used as the spacing member 1290. The electrode layer 1241 and the pressure sensing layer 1250 of the display module detect a change in capacitance when a displacement in distance between the electrode layer 1241 and the pressure sensing layer 1250 occurs to detect a magnitude of an applied pressure and are coupled to each other without being in contact with each other so as to maintain the capacitance. That is, in a default state in which no force is applied, the pressure sensing layer 1250 and the electrode layer 1241 of the display module 1240 are not in contact with each other, and even when a maximum displacement occurs at the pressure sensing layer 1250 due to application of a force to the screen cover 1210, the pressure sensing layer 1250 and the electrode layer 1241 are disposed and spaced apart from each other so as not to come into contact with each other. Meanwhile, according to the embodiment of FIG. 11, the pressure sensing layer 1250 and the electrode layer 1241 may be spaced apart from each other without including a separate spacing member. As shown in the drawing, the screen cover 1210, the touch sensing part 1230, the display module 1240, and the pressure sensing layer 1250 are coupled to the support frame 1220 by an adhesive member 1260′, and the display module 1240 and the pressure sensing layer 1250 are disposed and spaced apart by a predetermined distance using a height of the adhesive member 1260′ and a spacing member 1221 forming a side wall of the support frame 1220. The electrode layer 1241 may be a VCOM layer when an LCD is employed in a display module, and the electrode layer 1241 may be a cathode electrode when an OLED is employed.

The support frame 1220 may be a support frame configured to house the three-dimensional touch screen panel 1200, a middle frame configured to partition a display panel and electric components including a battery, or a blocking frame configured to block noise due to an electrical signal of a touch screen panel including a display panel. In the embodiment of FIG. 11, the support frame 1220 is a housing member of the three-dimensional touch screen panel 1200 and is configured to have a central opening through which the screen cover 1210 may be disposed and house the three-dimensional touch screen panel 1200.

The touch sensing part 1230 and the pressure sensing layer 1250 coupled to the screen cover 1210 by the adhesive layer 1260 may be preferably coupled to the support frame 1220 so as to allow a distance from the display module 1240 to be varied according to a pressure magnitude when the user touches the screen cover 1210, or the coupled layers 1230 and 1250 may preferably have elasticity so as to allow the distance from the display module 1240 to be varied according to the magnitude of the pressure when the screen cover 1201 is touched and so as to return to their original positions when the pressure is released.

Meanwhile, the microcontroller which is not included in the drawing determines a touch event, a touch position, and a pressure magnitude according to signals applied from the touch sensing part 1230 and the pressure sensing layer 1250.

An operation of the three-dimensional touch screen panel 1200 according to the second embodiment of the present invention will be described below. When the user touches the screen cover 1210, the coupled layers 1230 and 1250 are displaced toward the electrode layer 1241 of the display module 1240 according to an applied pressure. Capacitance changes when the distance between the electrode layer 1241 made of a conductive material and the pressure sensing layer 1250 is varied, and the microcontroller receiving a capacitance sensing signal determines a pressure magnitude through a variation in the capacitance. The microcontroller determines a touch event and a touch position according to a signal applied from the touch sensing part 1230. Accordingly, the three-dimensional touch screen panel 1200 according to the embodiment of the present invention determines the touch event and the touch position according to the signal applied from the touch sensing part 1230, and determines the pressure magnitude applied when the touch is generated according to a signal applied from the pressure sensing layer 1250, such that there is an advantage in that a complicated electrode pattern or a separate electrode pattern is not required. Further, as shown in FIGS. 6 to 8, the three-dimensional touch screen panel 1200 according to the embodiment of the present invention employs the pressure sensing layer 1250 at which the plurality of penetration parts 125a and/or incised parts 125b are formed, and thus it is possible to correct an error which occurs differently according to the pressure magnitude when a central position or a position in the vicinity of an edge of the screen cover 1210 is touched. Meanwhile, in the three-dimensional touch screen panel 1200 according to the second embodiment, the electrode of the touch sensing part 1230 is set to the ground when the pressure magnitude is sensed, such that it is possible to prevent occurrence of an error in pressure magnitude detection due to noise of the touch sensing part 1230. Further, the three-dimensional touch screen panel 1200 according to the second embodiment may utilize the electrode layer 141 of the display module 1240 without adding a separate member, thereby using the change of capacitance due to a displacement between the pressure sensing layers 1250 and the electrode layer 141 for the pressure magnitude detection. Accordingly, there is an advantage in that the configuration can be simplified and a manufacturing process and manufacturing costs can be reduced.

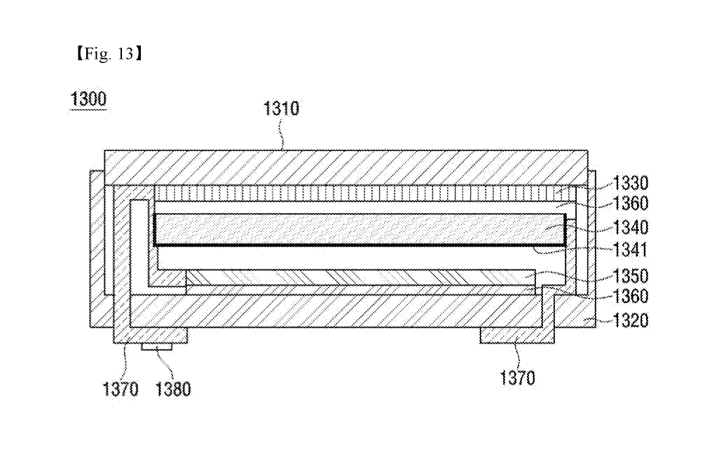

FIG. 13 illustrates a three-dimensional touch screen panel 1300 according to a third embodiment. FIG. 13 illustrates an embodiment in which a metal layer is a lower cover 1341 of a display panel 1340. The three-dimensional touch screen panel 1300 includes a screen cover 1310, a pressure sensing layer 1350, a touch sensing part 1330, a display module 1340, a support frame 1320, an adhesive layer 1360, a PCB module 1370, and a control IC 1380. A description of a configuration overlapping with the configurations of the above-described first and second embodiments will be omitted.

The pressure sensing layer 1350 is formed of a sheet made of a conductive material to detect pressure intensity when a touch event occurs. In the third embodiment, the pressure sensing layer 1350 is disposed at a bottom surface of the support frame 1320 and is fixed by the adhesive layer 1360. In the third embodiment, as shown in FIGS. 6 to 8, the pressure sensing layer 1350 at which the plurality of penetration parts 125a and/or incised parts 125b are formed is employed, and thus it is possible to correct an error which occurs differently according to a pressure magnitude when a position in the vicinity of a center or an edge of the screen cover 1310 is touched. A configuration of the penetration part 125a and/or the incised part 125b formed at the pressure sensing layer 1350 is included in the scope of the above description which is made with reference to FIGS. 6 to 8. Meanwhile, in the three-dimensional touch screen panel 1300 according to the second embodiment, the electrode of the touch sensing part 1330 is set to the ground when the pressure magnitude is sensed, such that it is possible to prevent occurrence of an error in pressure magnitude detection due to noise of the touch sensing part 1330.

The touch sensing part 1330 is configured to be coupled to the screen cover 1310 and detect a touch event and a touch position for the screen cover 1310. The touch sensing part 1330 is configured to be coupled to the screen cover 1310 and detect a touch event and a touch position for the screen cover 1310.

The display module 1340 is disposed below the touch sensing part 1330. The display module 1340 may be attached to a bottom surface of the touch sensing part 1330 by the adhesive layer 1360. The display module 1340 according to the embodiment of the present invention is housed by the lower cover 1341 made of a conductive material. The display module 1340 is disposed and spaced apart from the pressure sensing layer 1350 by a predetermined distance to emit light constituting screen information. The display module 1340 is attached to the bottom surface of the touch sensing part 1330, and thus the display module 1340 is displaced together with the screen cover 1310 in a direction of a force applied when the screen cover 1310 is touched. Accordingly, a distance between the display module 1340 and the pressure sensing layer 1350 positioned at the bottom surface of the support frame 1320 is varied. Although not shown in FIG. 13, a spacing member may be coupled between the display module 1340 and the pressure sensing layer 1350, and thus the lower cover 1341 of the display module 1340 and the pressure sensing layer 1350 may not be in contact with each other. The spacing member has elasticity to allow the screen cover 1310 to return to its original state after being displaced by a touch. The lower cover 1341 of the display module 1340 and the pressure sensing layer 1350 are configured to detect a change in capacitance when a displacement in distance between the lower cover 1341 of the display module 1340 and the pressure sensing layer 1350 occurs to detect a magnitude of an applied pressure and are coupled to each other without being in contact with each other so as to maintain the capacitance. That is, in a default state in which no force is applied, the pressure sensing layer 1350 and the lower cover 1341 of the display module 1340 are not in contact with each other, and even when a maximum displacement occurs at the pressure sensing layer 1350 due to application of a force to the screen cover 110, the pressure sensing layer 1350 and the lower cover 1341 are disposed and spaced apart from each other so as not to come into contact with each other. According to the third embodiment shown in FIG. 13, the display module 1340 and the pressure sensing layer 1350 may be spaced apart from each other using a side wall of the support frame 1320 without including a separate spacer member. The support frame 1320 may be a support frame configured to house the three-dimensional touch screen panel 1300, a middle frame configured to partition a display panel and electric components including a battery, or a blocking frame configured to block noise due to an electrical signal of a touch screen panel including a display panel. The touch sensing part 1330 and the display module 1340 coupled to the screen cover 1310 by the adhesive layer 1360 may be preferably coupled to the support frame 1320 so as to allow a distance from the pressure sensing layer 1350 to be varied according to a pressure magnitude when the user touches the screen cover 1310, or the coupled layers 1330 and 1340 may preferably have elasticity so as to allow the distance from the pressure sensing layer 1350 to be varied according to the pressure magnitude when the user touches the screen cover 1310 and so as to return to their original positions when the pressure is released.

Meanwhile, the microcontroller which is not included in the drawing determines a touch event, a touch position, and a pressure magnitude according to signals applied from the touch sensing part 1330 and the pressure sensing layer 1350.

An operation of the three-dimensional touch screen panel 1300 according to the third embodiment of the present invention will be described below. When the user touches the screen cover 1310, the coupled layers 1330 and 1340 are displaced toward the pressure sensing layer 1350 according to an applied pressure. Capacitance changes when the distance between the pressure sensing layer 1350 and the lower cover 1341 made of a conductive material and covering the display module 1340 is varied, and the microcontroller receiving a capacitance sensing signal determines a pressure magnitude through a variation in the capacitance. The microcontroller determines a touch event and a touch position according to a signal applied from the touch sensing part 1330. Accordingly, the three-dimensional touch screen panel 1300 according to the third embodiment of the present invention determines the touch event and the touch position according to the signal applied from the touch sensing part 1330, and the pressure magnitude applied when the touch is generated is determined according to a signal applied from the pressure sensing layer 1350, such that there is an advantage in that a complicated electrode pattern or a separate electrode pattern is not required. Further, the three-dimensional touch screen panel 1300 according to the embodiment of the present invention employs the pressure sensing layer 1350 at which the plurality of penetration parts 125a and/or incised parts 125a are formed, and thus it is possible to correct occurrence of an error in the pressure magnitude when a position in the vicinity of the center or the edge of the screen cover 1310 is touched. Further, the three-dimensional touch screen panel 1300 according to the embodiment may utilize the lower cover 1341 of the display module 1340 without adding a separate member, thereby using the change of capacitance due to a displacement between the pressure sensing layer 1350 and the lower cover 1341 in the pressure magnitude detection. Therefore, according to the third embodiment, there is an advantage in that the configuration can be simplified and a manufacturing process and manufacturing costs can be reduced.

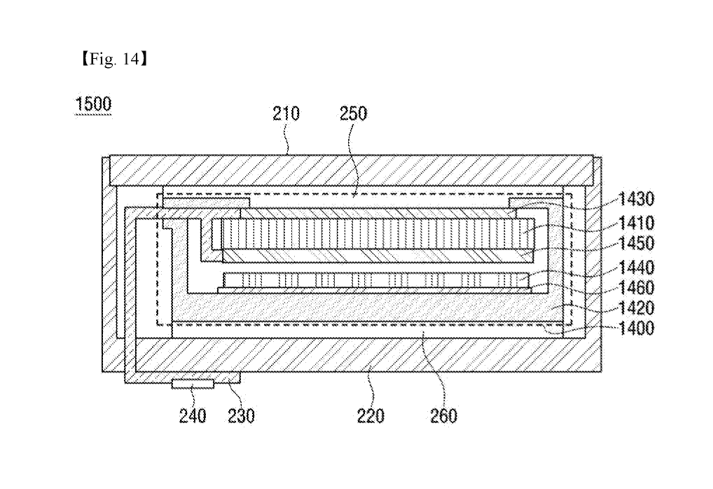

FIG. 14 illustrates a three-dimensional touch screen panel 1500 according to a fourth embodiment. FIG. 14 illustrates an embodiment in which a metal layer is a cover 1420 of an LCD module 1400. As shown in the drawing, the three-dimensional touch screen panel includes a screen cover 210, the LCD module 1400 including a touch sensing part 1430, a pressure sensing layer 1450, and the conductive cover 1420, a support frame 220, an adhesive member 250, a reflector 260, a PCB module 230, and a control IC 240. A description of a configuration overlapping with the configurations of the above-described first to third embodiments will be omitted.

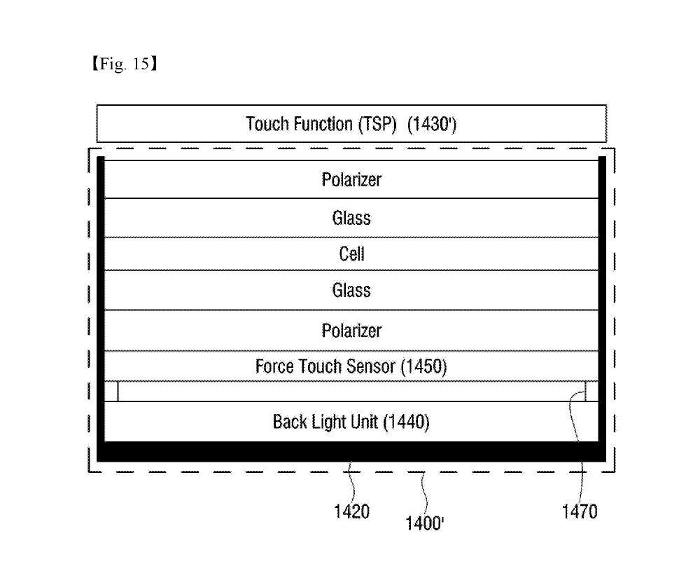

Meanwhile, FIGS. 15 to 17 illustrate cross sections of examples of LCD modules 1400′, 1400″, and 1400′″ applied to the embodiment of FIG. 14. FIG. 15 is a cross-sectional view of a touch sensing part 1430′ and the LCD module 1400′ of an add-on type touch screen, and the touch sensing part 1430 is adhered on the LCD module 1400. In the case of the add-on type, a touch panel including the touch sensing part 1430 and an LCD panel are separately manufactured and then adhered to each other. As shown in the drawing, in the LCD module 1400′ according to the embodiment of FIG. 15, a first polarizer, a first glass layer, a cell layer, a second glass layer, and a second polarizer are sequentially coupled from a top side, and the pressure sensing layer 1450 is coupled to a lower portion of the second polarizer, and a back light unit 1440 is disposed and spaced apart from the pressure sensing layer 1450. Further, the LCD module cover 1420 made of a conductive material houses the above-described layers. A spacing member 1470 is coupled between the pressure sensing layer 1450 and the back light unit 1440 to maintain a spacing between the pressure sensing layer 1450 and the back light unit 1440. A DAT or the like may be used as the spacing member 1470. The back light unit 1440 is attached to a bottom surface of the LCD module cover 1420. The back light unit 1440 may include several optical parts. The pressure sensing layer 1450 faces the LCD module cover 1420 made of a conductive material by interposing the back light unit 1440.

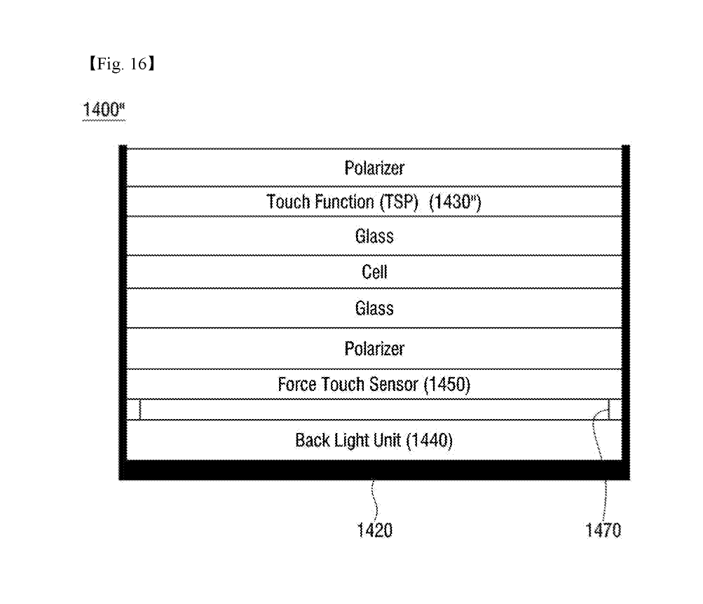

FIG. 16 is a cross-sectional view of the LCD module 1400″ of an on-cell type touch screen, and the LCD module 1400″ is an embedded type in which a touch sensing part 1430″ is included in the LCD panel 1400″. The on-cell touch type sensing part 1430″ is manufactured by thin film deposition of ITO on an upper glass layer among glass layers interposing a liquid crystal layer (cell). A first polarizer may be coupled on the touch sensing part 1430″, and a second polarizer may also be coupled to a lower side of a lower glass layer. The pressure sensing layer 1450 is coupled to a lower side of the second polarizer. The back light unit 1440 is disposed and spaced apart from the pressure sensing layer 1450. Further, the LCD module cover 1420 made of a conductive material houses the above-described layers. A spacing member 1470 is coupled between the pressure sensing layer 1450 and the back light unit 1440 to maintain a spacing between the pressure sensing layer 1450 and the back light unit 1440. A DAT or the like may be used as the spacing member 1470. The back light unit 1440 is attached to the bottom surface of the LCD module cover 1420. The back light unit 1440 may include several optical parts. The pressure sensing layer 1450 faces the LCD module cover 1420 made of a conductive material by interposing the back light unit 1440.

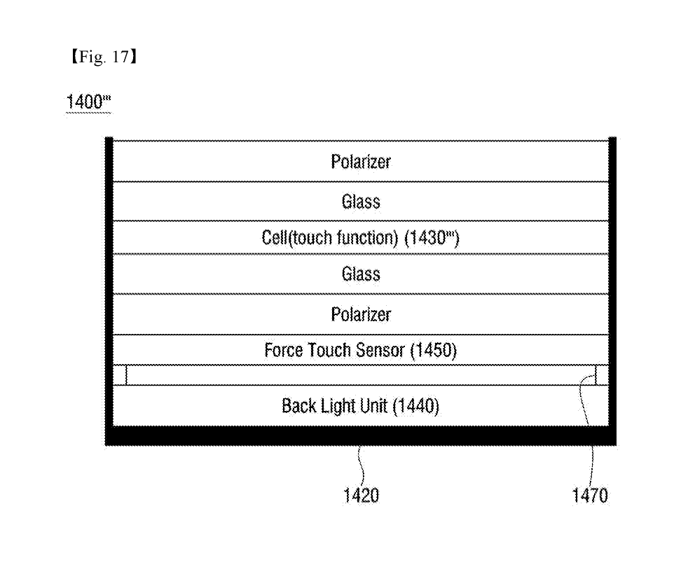

FIG. 17 is a cross-sectional view of the LCD module 1400′″ of an in-cell type touch screen, and the LCD module 1400′″ is an embedded type in which a touch sensing part 1430′″ is included in the LCD module 1400′″. In the in-cell type touch sensing part 1430′″, an ITO thin film is deposited inside a liquid crystal layer, i.e., a cell. A glass layer is coupled to each of a front surface and a back surface of the liquid crystal layer, and a polarizer is coupled to the glass layer. The pressure sensing layer 1450 is coupled to a lower side of the polarizer below the liquid crystal layer (cell). The back light unit 1440 is disposed and spaced apart from the pressure sensing layer 1450. Further, the LCD module cover 1420 made of a conductive material houses the above-described layers. A spacing member 1470 is coupled between the pressure sensing layer 1450 and the back light unit 1440 to maintain a spacing between the pressure sensing layer 1450 and the back light unit 1440. A DAT or the like may be used as the spacing member 1470. The back light unit 1440 is attached to the bottom surface of the LCD module cover 1420. The back light unit 1440 may include several optical parts. The pressure sensing layer 1450 faces the LCD module cover 1420 made of a conductive material by interposing the back light unit 1440.

In the embodiments of FIGS. 15 to 17, the pressure sensing layer 1450 is formed of a sheet made of a transparent conductive material to detect pressure intensity when a touch event occurs. A transparent conducting oxide (TCO) such as ITO, a silver nanowire, a CNT, or a graphene may be used as the pressure sensing layer 1450. In the embodiments of FIGS. 15 to 17, the pressure sensing layer 1450 is manufactured together with the LCD module 1400′, 1400″, 1400′″ instead of being separately manufactured from the LCD module 1400′, 1400″, 1400′″. As shown in FIGS. 6 to 8, the plurality of penetration parts 125a may be formed at the pressure sensing layer 1450. The plurality of penetration parts 125 may be formed to increase in area from an edge of the pressure sensing layer 1450 to a central portion thereof. As shown in FIGS. 6 to 8, when the penetration part 125a and/or the incised part 125b is formed at the pressure sensing layer 1450, it is possible to correct an error in pressure magnitude detection when a central portion of the screen cover 210 is touched and when an edge of the screen cover 210 is touched.

In the embodiment of FIG. 14, the support frame 220, together with the screen cover 210, may perform a housing function to enclose circuitry for operations of the LCD panel 1400 and the touch screen panel. The support frame 220 may be made of a conductive material or a non-conductive material. The LCD module 100 may be fixed to a bottom surface of the support frame 220 by an adhesive member.

As described above with reference to FIGS. 15 to 17, the touch sensing part 1430 and the pressure sensing layer 1450 may be coupled inside the LCD module 1400″ or 1400′″ (an on-cell or in-cell type) or be coupled on the LCD module 1400′ (an add-on type). The touch sensing part 1430 is configured to detect a touch event and a touch position for the screen cover 210.

The LCD module 1400 including the touch sensing part 1430 may be attached to a bottom surface of the screen cover 210 by the adhesive member 250. The LCD module 1400 according to the embodiment of the present invention is housed by the LCD module cover 1420 made of a conductive material. The pressure sensing layer 1450 disposed within the LCD module 1400 is displaced together with the screen cover 210 in a direction of a force applied when the screen cover 210 is touched. Accordingly, a distance between the bottom surface of the LCD module cover 1420 and the pressure sensing layer 1450 is varied. A spacing member 1470 is coupled between the LCD module cover 1420 and the pressure sensing layer 1450, and thus the LCD module cover 1420 and the pressure sensing layer 1450 are spaced apart from each other and are not in contact with each other. The spacing member has elasticity to allow the screen cover 210 to return to its original state after being displaced by a touch. The pressure sensing layer 1450 detects a change in capacitance when a displacement in distance between the LCD module cover 1420 and the pressure sensing layer 1450 is generated to detect a magnitude of an applied pressure, and the LCD module cover 1420 and the pressure sensing layer 1450 are coupled without being in contact with each other so as to maintain the capacitance. The LCD module cover 1420 made of a conductive material is preferably set to the ground or a set voltage.

The support frame 220 may be a support frame configured to house the three-dimensional touch screen panel 1500, a middle frame configured to partition a display panel and electric components including a battery, or a blocking frame configured to block noise due to an electrical signal of a touch screen panel including a display panel.

The adhesive member 250 adheres and couples the LCD module 1400 to the screen cover 210.

An operation of the three-dimensional touch screen panel 1500 according to the fourth embodiment of the present invention will be described below. When the user touches the screen cover 210, the layers including the pressure sensing layer 1450 are displaced toward the LCD module cover 1420 according to an applied pressure. Capacitance changes when the distance between the LCD module cover 1420 made of a conductive material and the pressure sensing layer 1450 is varied, and the microcontroller receiving a capacitance sensing signal determines a pressure magnitude through a variation in the capacitance. The microcontroller determines a touch event and a touch position according to a signal applied from the touch sensing part 1430. Accordingly, the touch screen panel according to the fourth embodiment of the present invention determines the touch event and the touch position according to the signal applied from the touch sensing part 1430, and determines the pressure magnitude applied when the touch is generated according to a signal applied from the pressure sensing layer 1450, such that there is an advantage in that a complicated electrode pattern or a separate electrode pattern is not required. Further, the three-dimensional touch screen panel 1500 according to the embodiment of the present invention employs the pressure sensing layer 1450 at which the plurality of penetration parts 125a and/or incised parts 125b are formed, and thus it is possible to correct occurrence of an error in the pressure magnitude when a position in the vicinity of the center or the edge of the screen cover 210 is touched. Furthermore, the three-dimensional touch screen panel 1500 according to the embodiment may utilize the LCD module cover 1420 without adding a separate member, thereby using the change of capacitance due to a displacement between the pressure sensing layer 1450 and the LCD module cover 1420 in the pressure magnitude detection. Therefore, the embodiments of the present invention has an advantage in that the configuration can be simplified and a manufacturing process and manufacturing costs can be reduced.

1. A three-dimensional touch panel, comprising:
a touch surface to which a user's touch is applied;
a first electrode made of a conductive material and positioned below the touch surface; and
a second electrode made of a conductive material and spaced apart from and below the first electrode,
wherein a distance between the first electrode and the second electrode is varied according to a pressure applied to the touch surface,
one or more penetration parts penetrating in a thickness direction are formed at either the first electrode or the second electrode, and
the one or more penetration parts increase in area from an edge to a center.

2. The three-dimensional touch panel of claim 1, wherein an incised part which is incised inward is formed on at least one edge of either the first electrode or the second electrode.

3. The three-dimensional touch panel of claim 1, wherein either the first electrode or the second electrode is configured with a plurality of separate electrodes.

4. The three-dimensional touch panel of claim 1, wherein either the first electrode or the second electrode outputs a pressure sensing signal corresponding to capacitance which changes according to the distance.

5. The three-dimensional touch panel of claim 1, further comprising a touch sensing part positioned below the touch surface and configured to detect a touch position with respect to the touch surface.

6. The three-dimensional touch panel of claim 5, further comprising a display module positioned below the touch surface.

7. The three-dimensional touch panel of claim 6, further comprising a frame configured to fix an edge of the three-dimensional touch panel.

8. The three-dimensional touch panel of claim 1, further comprising a spacer layer disposed between the first electrode and the second electrode and configured to separate the first electrode from the second electrode.

9. The three-dimensional touch panel of claim 1, wherein the first electrode or the second electrode is a metal layer.

10. The three-dimensional touch panel of claim 9, further comprising a display panel,
wherein the metal layer is an electrode layer included in the display panel.

11. The three-dimensional touch panel of claim 9, further comprising a middle frame configured to house the three-dimensional touch panel,
wherein the metal layer is the middle frame.

12. The three-dimensional touch panel of claim 9, further comprising a blocking frame configured to block between the three-dimensional touch panel and electric components including a battery,
wherein the metal layer is the blocking frame.

13. A three-dimensional touch panel, comprising:
a pressure sensing layer coupled parallel to a touch surface of the three-dimensional touch panel, configured to output a signal corresponding to capacitance changing according to a magnitude of a pressure applied to the touch surface, having one or more penetration parts penetrating in a thickness direction, and made of a conductive material,
wherein the one or more penetration parts increase in area from an edge to a center.

14. (canceled)

15. A three-dimensional touch screen panel, comprising:
a screen cover;
a touch sensing part positioned below the screen cover and configured to detect a touch position with respect to the screen cover;
a display module positioned below the touch sensing part;
a pressure sensing layer positioned below the display module, configured to output a signal corresponding to capacitance changing according to a magnitude of a pressure applied to the screen cover, and made of a conductive material; and
a frame made of a conductive material, disposed below the pressure sensing layer and spaced apart from the pressure sensing layer, and configured to be varied in distance from the pressure sensing layer according to the pressure,
wherein one or more penetration parts penetrating in a thickness direction are formed at the pressure sensing layer, and
the one or more penetration parts increase in area from an edge of the pressure sensing layer to a center thereof.

16. The three-dimensional touch screen panel of claim 15, wherein the frame partitions the display module from a battery.

17. The three-dimensional touch screen panel of claim 15, wherein an edge of the screen cover is connected and fixed to the frame.

18. The three-dimensional touch screen panel of claim 15, wherein an edge of the screen cover is fixed by an additional frame.

19-30. (canceled)
